(19) United States
(12) Patent Application Publication
(10) Pub. No.: US 2013/0323567 A1
(43) Pub. Date: Dec. 5, 2013

(54) MOLTEN SALT BATTERY AND METHOD FOR PRODUCTION THEREOF

(71) Applicants: Shoichiro Saki, Osaka-shi (JP); Atsushi Fukunaga, Osaka-shi (JP); Koji Nitta, Osaka-shi (JP); Shinji Inazawa, Osaka-shi (JP)

(72) Inventors: Shoichiro Saki, Osaka-shi (JP); Atsushi Fukunaga, Osaka-shi (JP); Koji Nitta, Osaka-shi (JP); Shinji Inazawa, Osaka-shi (JP)

(73) Assignee: SUMITOMO ELECTRIC INDUSTRIES, LTD., Osaka-shi, Osaka (JP)

(21) Appl. No.: 14/000,589

(22) PCT Filed: Feb. 15, 2012
(86) PCT No.: PCT/JP2012/053462

§ 371 Date: Aug. 20, 2013

(30) Foreign Application Priority Data
Feb. 21, 2011 (JP) 2011 034192

(51) Int. Cl. H01M 2/02

(52) U.S. Cl. CPC H01M 2/02; H01M 2/0202; H01M 2/0237
USPC 429/127; 29/623.1

(57) ABSTRACT

It is an object to provide a molten salt battery which is capable of stably performing charging and discharging without using an internal elastic body for pressure contact as an essential constituent element. For achieving the object, the molten salt battery of the present invention includes: a molten salt battery body in which positive electrodes and negative electrodes are alternately stacked with a separator containing molten salt as an electrolyte interposed between the positive electrode and the negative electrode; and a battery case which is formed of a material having flexibility and hermetically covers the molten salt battery body while exposing only terminal parts from the positive electrode and negative electrode. When the battery case is brought into a negative pressure state at the inside, the battery case itself compresses the molten salt battery body in a stacking direction under external pressure based on atmospheric pressure.

### TECHNICAL FIELD

The present invention relates to a structure of a battery having a molten salt as an electrolyte, and a method for production thereof. The molten salt also includes an ionic liquid which is melted at room temperature.

### BACKGROUND ART

In recent years, electric power generation using natural energy such as sunlight and wind power has been promoted as a means for generating electric power without emission of carbon dioxide. In electric power generation by natural energy, leveling of electric power supply with respect to a load is absolutely necessary because not only the amount of electric power generation often depends on natural conditions such as climate and weather, but also it is difficult to adjust the amount of electric power generation in accordance with the demand for electric power. For achieving leveling by charging and discharging electric energy generated, a storage battery having a high energy density/high efficiency and a large capacity is required, and as a storage battery that satisfies such a requirement, a molten salt battery using a molten salt for an electrolyte has been receiving attention.

For instance, a single cell of a molten salt battery has, in a battery container, an electric power generation element in which a separator impregnated with a molten salt composed of a cation of an alkali metal such as sodium or potassium and an anion including fluorine is interposed between a positive electrode formed by including, in a current collector, an active material composed of a compound of sodium and a negative electrode formed by plating the current collector with a metal such as tin. Positive electrodes and negative electrodes are alternately arranged with a separator interposed between the positive electrode and the negative electrode to form a molten salt battery body having a stacked structure.

As a battery container, a metallic container made of aluminum or an aluminum alloy is preferable from the viewpoint of weight reduction and corrosion resistance (see, for example, Patent Literature 1). The molten salt battery body is stored closely in the battery container while the positive electrode and the negative electrode are maintained in pressure contact with the separator. In other words, the above-mentioned pressure contact state is maintained by appropriately designing a dimension of the molten salt battery body in a stacking direction and an inner dimension of the battery container. The maintenance of a constant pressure contact state is meaningful in that the amount of sodium intercalated or precipitated at the positive electrode and the negative electrode is stably maintained to prevent a variation in charging and discharging.

In practice, however, such a phenomenon occurs that the positive electrode and the negative electrode expand in the stacking direction at the time of charge and contract at the time of discharge. Therefore, a constant pressure contact state cannot be maintained in the molten salt battery body merely by storing the molten salt battery body in the battery container. Accordingly, the present applicant has proposed a molten salt battery including in a battery container an elastic body such as a spring or rubber, and a flat plate-shaped presser plate for making the distribution of the elastic repulsion force of the elastic body even (Japanese Patent Application No. 2010-267261). FIG. 7 is a cross-sectional view of the molten salt battery.

In FIG. 7, in the molten salt battery, a molten salt battery body part 100 as an electric power generation element, and also a corrugated plate-shaped spring 120 and a presser plate 130 are stored in a metallic battery container 110. In this case, the spring 120 is elastically deformed so as to absorb or compensate for expansion or contraction of the positive electrode and the negative electrode, so that an almost constant pressure contact state is maintained. The presser plate 130 makes the planar distribution of the elastic repulsion force of the spring 120 even.

### CITATION LIST

### Patent Literature

Patent Literature 1: Japanese Unexamined Patent Publication No. 2009-211936 (paragraph [0067], FIG. 1)

### SUMMARY OF INVENTION

### Technical Problem

However, when an electric body and presser plate as described above are provided, their occupancy spaces are required, and the total volume of a molten salt battery including a battery container is accordingly increased, leading to a decrease in battery capacity per unit volume (Wh/L). The space is so called an air-cooled space, and has a low heat conductivity, and therefore efficiency of heating for keeping the molten salt at its melting point or higher is accordingly deteriorated.

In view of such conventional problems, an object of the present invention is to provide a molten salt battery capable of performing stable charging and discharging without using an internal elastic body for pressure contact as an essential constituent element.

### Solution to Problem

(1) A molten salt battery of the present invention includes: a molten salt battery body in which positive electrodes and negative electrodes are alternately stacked with a separator containing molten salt as an electrolyte interposed between the positive electrode and the negative electrode; and a battery case which is at least partially formed of a material having flexibility and hermetically covers the molten salt battery body while exposing only terminal parts from the positive electrode and negative electrode, and compresses the molten salt battery body in a stacking direction in a state that external pressure based on atmospheric pressure acts on a part of the material with a negative pressure made inside the battery case.

Here, the material having flexibility is a material which is deformed, e.g. bent, under external pressure based on atmospheric pressure (atmospheric pressure-negative pressure at the inside), for example a pressure of about 0.5 atmosphere.

In the molten salt battery configured as described above, the molten salt battery body is constantly compressed in the stacking direction under external pressure based on atmospheric pressure (atmospheric pressure-negative pressure at the inside), so that the positive and negative electrodes and the separator are stably in pressure contact with each other. For example, when the negative pressure is 0.5 atmosphere or less, a sufficient pressure contact force based on atmospheric pressure is obtained. The positive electrode and the negative electrode expand or contract at the time of charging and discharging, but even in this case, the stable pressure contact state is not changed because the external pressure acts via the flexible part of the battery case which conforms to expansion/contraction. Accordingly, a stable even current distribution is achieved at the time of charging and discharging. Therefore, it is not necessary to provide an elastic body such as a spring in the battery case. When the elastic body is omitted, a space therefor is not needed, and therefore the battery capacity per unit volume of the molten salt battery is increased. A reduction in space leads an improvement in efficiency of heating for keeping the molten salt at its melting point or higher.

(2) In the molten salt battery in (1), the battery case may be a laminate film which is sealed while covering the molten salt battery body, the laminate film including an aluminum foil and a resin layer.

In this case, flexibility and air tightness can be easily ensured at low costs, and a desired heat-resistant temperature can be easily achieved by appropriately selecting a material of the resin layer.

(3) In the molten salt battery in (1) or (2), the molten salt may be a mixture containing NaFSA or LiFSA.

(4) In the molten salt battery in (1) or (2), the molten salt may be a mixture containing NaTFSA or LiTFSA.

(5) In the molten salt battery in (1) or (2), the molten salt may be a mixture of NaFSA and KFSA, or a mixture of LiFSA, KFSA and CsFSA.

In these cases, the molten salt of each mixture has a relatively low melting point, and therefore the molten salt battery can be operated at a low level of heating. A relatively low temperature is sufficient as a heat-resistant temperature required for the battery case, so that selection of a material of the battery case is easy.

(6) On the other hand, the present invention is a method for producing a molten salt battery including: a molten salt battery body in which positive electrodes and negative electrodes are alternately stacked with a separator containing molten salt as an electrolyte interposed between the positive electrode and the negative electrode; and a battery case which is at least partially formed of a material having flexibility and hermetically covers the molten salt battery body while exposing only terminal parts from the positive electrode and negative electrode, the method comprising: making a negative pressure inside the battery case while heating is carried out for keeping the molten salt at its melting point or higher to thereby compress the molten salt battery body in a stacking direction in a state that external pressure based on atmospheric pressure acts on a part of the material.

In the method for production of a molten salt battery as described above, undesired moisture remaining in the battery case can be evaporated by heating. By pressure reduction for achieving the negative pressure, evaporation of moisture is accelerated.

In the produced molten salt battery, the molten salt battery body is constantly compressed in the stacking direction under external pressure based on atmospheric pressure (atmospheric pressure-negative pressure at the inside), so that the positive and negative electrodes and the separator are stably in pressure contact with each other. For example, when the negative pressure is 0.5 atmosphere or less, a sufficient pressure contact force based on atmospheric pressure is obtained. The positive electrode and the negative electrode expand or contract at the time of charging and discharging, but even in this case, the stable pressure contact state is not changed because the external pressure acts via the flexible part of the battery case which conforms to expansion/contraction. Accordingly, a stable even current distribution is achieved at the time of charging and discharging. Therefore, it is not necessary to provide an elastic body such as a spring in the battery case. When the elastic body is omitted, a space therefor is not needed, and therefore the battery capacity per unit volume of the molten salt battery is increased. A reduction in space leads an improvement in efficiency of heating for keeping the molten salt at its melting point or higher.

### Advantageous Effects of Invention

According to the molten salt battery of the present invention, stable charging and discharging can be performed without using an internal elastic body for pressure contact as an essential constituent element. According to the method for production of a molten salt battery in the present invention, undesired moisture in a battery case can be evaporated at a stage of producing the molten salt battery.

### BRIEF DESCRIPTION OF DRAWINGS

FIG. 1 is a schematic view illustrating in principle a basic structure of an electric power generation element in a molten salt battery.

FIG. 2 is a perspective view briefly illustrating a stacked structure of the molten salt battery.

FIG. 3 is a cross-sectional view of a structure similar to that in FIG. 2.

FIG. 4 is a cross-sectional view illustrating one example of a state in which a terminal is drawn out from each of a positive electrode and a negative electrode.

FIG. 5A is a sectional view illustrating a state in which a molten salt battery body (body part excluding a battery case) is covered with a battery case, which is a laminate film, so as to envelop the molten salt battery body, and FIG. 5B is a sectional view illustrating a state after evacuation is performed, or a state in which the battery case sealed in vacuum is taken out into an environment under atmospheric pressure.

FIG. 6A and FIG. 6B are a sectional view and a front view, respectively, when terminal parts are drawn out in the same direction from the battery case.

FIG. 7 is a cross-sectional view of a molten salt battery including a spring.

### DESCRIPTION OF EMBODIMENTS

A molten salt battery according to one embodiment of the present invention will be described below with reference to the drawings.

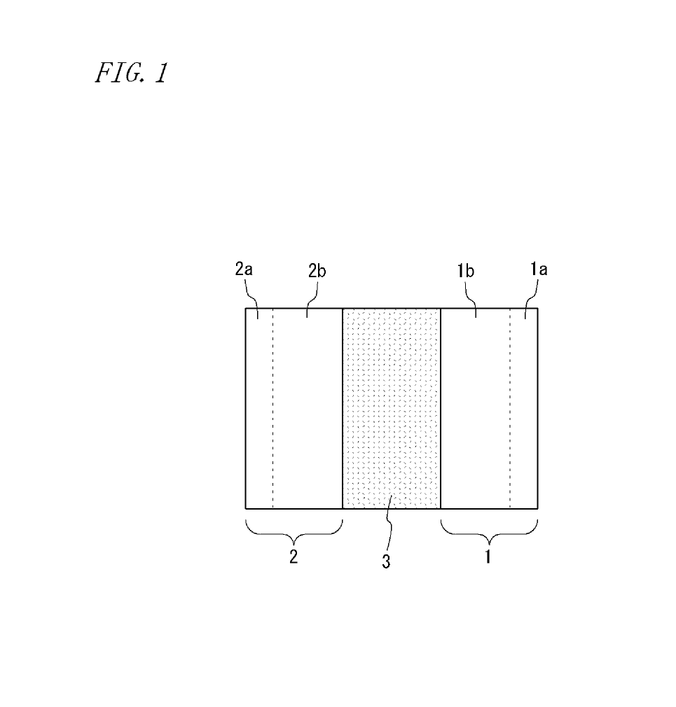

FIG. 1 is a schematic view illustrating in principle a basic structure of an electric power generation element in the molten salt battery. In the figure, the electric power generation element includes a positive electrode 1, a negative electrode 2 and a separator 3 interposed therebetween. The positive electrode 1 includes a current collector of positive electrode 1a and a positive electrode material 1b. The negative electrode 2 includes a current collector of negative electrode 2a and a negative electrode material 2b.

A material of the current collector of positive electrode 1a is, for example, an aluminum nonwoven fabric (line diameter: 100 μm; porosity: 80%). The positive electrode material 1b is obtained by mixing a positive electrode active material such as, for example, NaCrO₂, acetylene black, PVDF (polyvinylidene fluoride) and N-methyl-2-pyrrolidone at a mass ratio of 85:10:5:50. The current collector of positive electrode 1a that is an aluminum nonwoven fabric is filled with the resulting mixture, dried, and then pressed at 100 MPa to form the positive electrode 1 in a thickness of about 1 mm.

On the other hand, in the negative electrode 2, a negative electrode active material such as, for example, a Sn—Na alloy containing tin (operation temperature: 90° C.) is formed by plating on the current collector of negative electrode 2a made of aluminum.

The separator 3 interposed between the positive electrode 1 and the negative electrode 2 is obtained by impregnating a nonwoven fabric of glass (thickness: 200 μm) with a molten salt as an electrolyte. The molten salt is for example, a mixture of 56 mol % NaFSA (sodium bisfluorosulfonylamide) and 44 mol % KFSA (potassium bisfluorosulfonylamide), and has a melting point of 57° C. At a temperature equal to or higher than the melting point, the molten salt is melted to contact the positive electrode 1 and the negative electrode 2 in the form of an electrolytic solution with ions dissolved therein at a high concentration. The molten salt is incombustible.

The materials/components of the parts and the values described above represent one preferred example, but the present invention is not limited thereto.

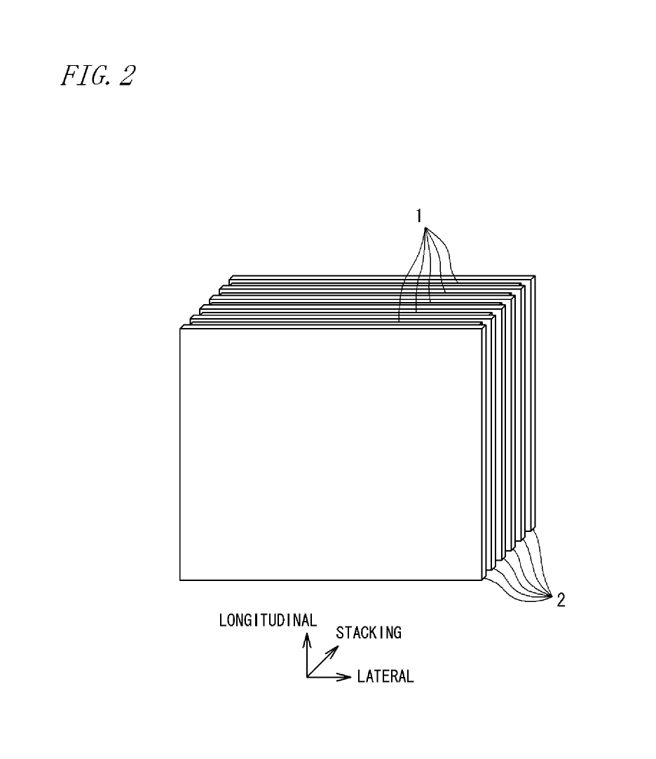

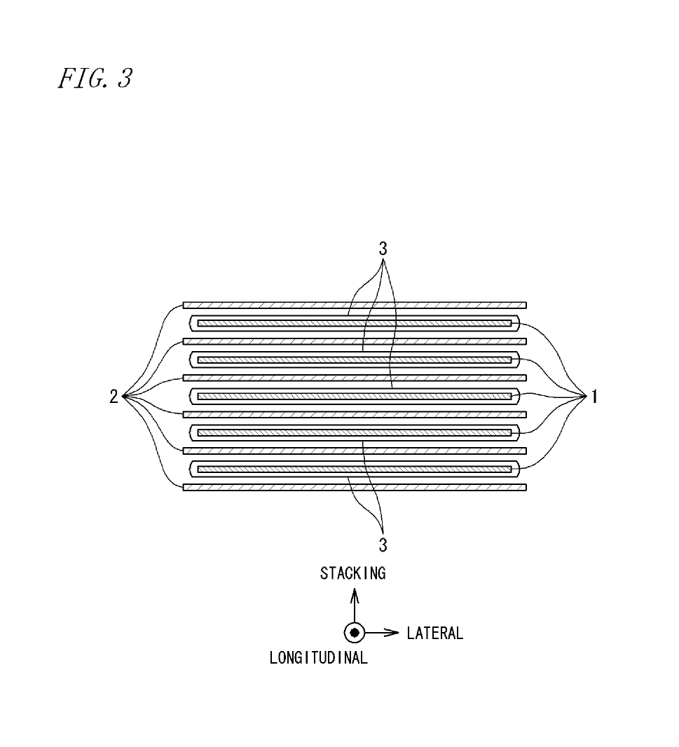

Next, a more specific configuration of the electric power generation element of the molten salt battery will be described below. FIG. 2 is a perspective view briefly illustrating a stacked structure of the molten salt battery, and FIG. 3 is a cross-sectional view of a similar structure.

In FIG. 2 and FIG. 3, a plurality of rectangular flat plate-shaped negative electrodes 2 (6 negative electrodes are illustrated), and a plurality of rectangular flat plate-shaped positive electrodes 1 (5 positive electrodes are illustrated) stored in bag-shaped separators 3 are superimposed on one another in a vertical direction in FIG. 3, i.e. a stacking direction, with the positive electrode 1 and the negative electrode 2 facing each other, so that a stacked structure is formed.

The separator 3 is interposed between the adjacent positive electrode 1 and negative electrode 2, and in other words, positive electrodes 1 and negative electrodes 2 are alternately stacked with the separator 3 interposed between the positive electrode 1 and the negative electrode 2. As the number of these components that are stacked in practice, for example, the number of positive electrodes 1 is 20, the number of negative electrodes 2 is 21, and the number of separators 3 is 20 as “bags”, but the number of separators 3 each interposed between the positive electrode 1 and the negative electrode 2 is 40. The separator 3 is not necessarily bag-shaped, but there may be 40 separated separators.

In FIG. 3, it seems that the separator 3 and the negative electrode 2 are separated from each other, but they are in close contact with each other at the time when the molten salt battery is completed. The positive electrode 1 is also in close contact with the separator 3 as a matter of course. The dimension of the positive electrode 1 in each of the longitudinal direction and the lateral direction is made smaller than the dimension of the negative electrode 2 in the longitudinal direction and the lateral direction for preventing generation of a dendrite, and the outer periphery of the positive electrode 1 faces the circumferential peripheral part of the negative electrode 2 with the separator 3 interposed therebetween.

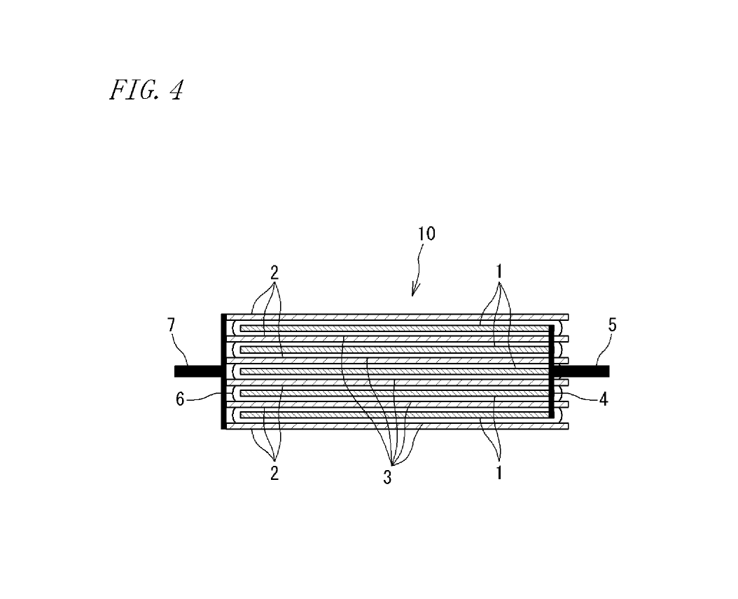

FIG. 4 is a cross-sectional view illustrating one example of a state in which a terminal is drawn out from each of the positive electrode 1 and the negative electrode 2. A plurality of positive electrodes 1 are connected to one another by a connection member 4, and drawn out as a terminal part 5. Similarly, a plurality of negative electrodes 2 are connected to one another by a connection member 6, and drawn out as a terminal part 7. For how the terminal is drawn out (direction in which the terminal is drawn out, connection member and shape of terminal part), various other forms are possible, and this figure merely illustrates one example.

Next, the battery case will be described. The battery case is made not of a metal having high rigidity, but of a material having flexibility and airtightness. Typically, a laminate film obtained by forming resin layers on both surfaces of an aluminum foil is preferred. For example, a laminate film having a three-layer structure of a polyethylene terephthalate (PET) layer (12 μm), an aluminum foil (40 μm) and a polypropylene (PP) layer (50 μm) can be used. For enhancing heat resistance and corrosion resistance, a resin such as a fluororesin, polyethylene naphthalate (PEN), polyimide (PI) or polyphenylene sulfide (PPS) may be used. As a heat-resistant temperature, a laminate film having a heat resistance of at least about 100° C. with a margin added to 80° C., i.e. a general operation temperature of the molten salt battery.

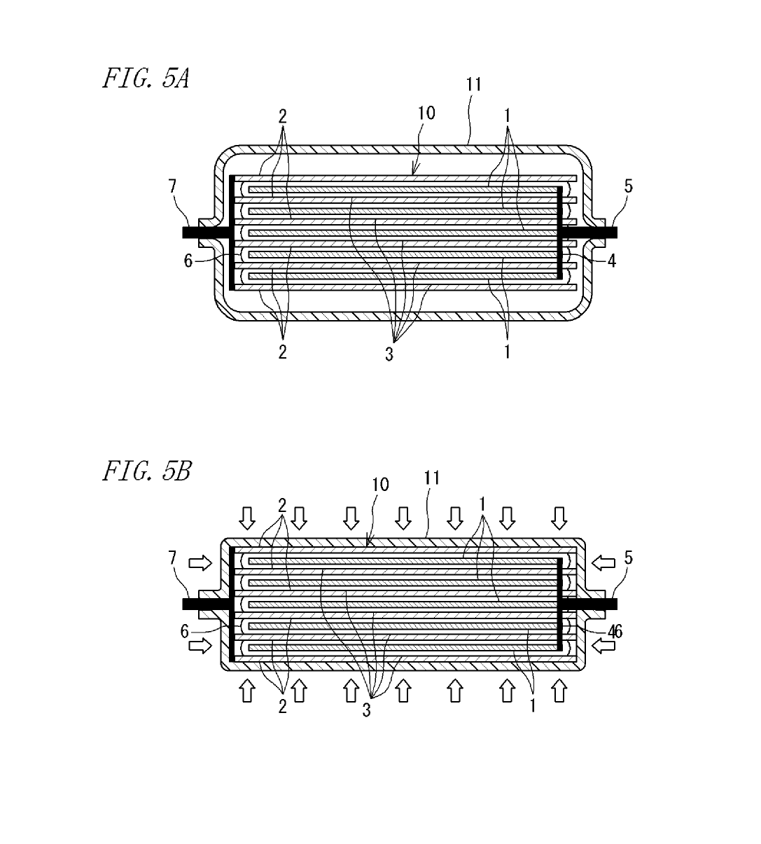

FIG. 5A illustrates a state in which a molten salt battery body (body part excluding a battery case 11) 10 is covered with a battery case 11, which is a laminate film, so as to envelop the molten salt battery body 10. It is to be noted that the figure is aimed mainly at plainly explaining the structure, and the dimension and thickness of each illustrated part are not necessarily proportion to the exact size.

For covering the molten salt battery body 10 as described above, for example, the molten salt battery body 10 is placed in a laminate film formed in a bag shape or cylindrical shape, and openings are sealed by, for example, thermal welding while only terminal parts 5 and 7 are exposed. The molten salt battery body 10 may be sandwiched between two laminate films, and the outer peripheries are sealed together in the same manner as described above.

The above-mentioned “sealing” requires a step of creating vacuum in the internal space of the battery case 11 before the sealing is completely performed. The vacuum mentioned herein means a state of negative pressure lower than atmospheric pressure, which is a level of low vacuum defined in JIS (100 Pa or higher). Specifically, the target value as negative pressure is preferably 0.5 atmosphere or lower. For example, a vacuum pump (not illustrated) is operated, and a suction nozzle is inserted beside the terminal part 5 or 7, so that the internal space is evacuated. Gaps in the battery case 11 are sealed completely at the same time as completion of the evacuation step. In the mass production process, the battery case 11 may be sealed while covering the molten salt battery body 10 in the space of a vessel kept at vacuum, and thereafter taken out into an environment at atmospheric pressure.

The evacuation and sealing step, or the step of sealing the battery case 11 while covering the molten salt battery body 10 therewith in vacuum is performed while the molten salt battery body 10 is heated at a temperature in a range of 60 to 150° C. using external heating means (heater, etc.) (not illustrated). In this case, undesired moisture remaining in the battery case 11 can be evaporated by heating. By pressure reduction for achieving the negative pressure, evaporation of moisture is accelerated.

FIG. 5B is a sectional view illustrating a state after evacuation is performed, or a state in which the battery case sealed in vacuum is taken out into an environment under atmospheric pressure. In this state, external pressure based on atmospheric pressure (atmospheric pressure-negative pressure at the inside) acts on the entire outer surface of the battery case 11 as shown by the arrow. Particularly, the external pressure based on atmospheric pressure acts uniformly on side surfaces having a relatively large area (upper and lower surfaces in FIG. 5B). Consequently, the molten salt battery body 10 is constantly compressed in the stacking direction, so that the positive electrode 1 and negative electrode 2 and the separator 3 are stably in pressure contact with each other. Particularly, when the pressure is sufficiently reduced (to 0.5 atmosphere or lower), a strong pressure contact force based on atmospheric pressure is achieved. The positive electrode 1 and the negative electrode 2 expand or contract at the time of charging and discharging, but even in this case, the stable pressure contact state is not changed because the external pressure acts via the flexible battery case 11 which conforms to expansion/contraction. Accordingly, a stable even current distribution is achieved at the time of charging and discharging.

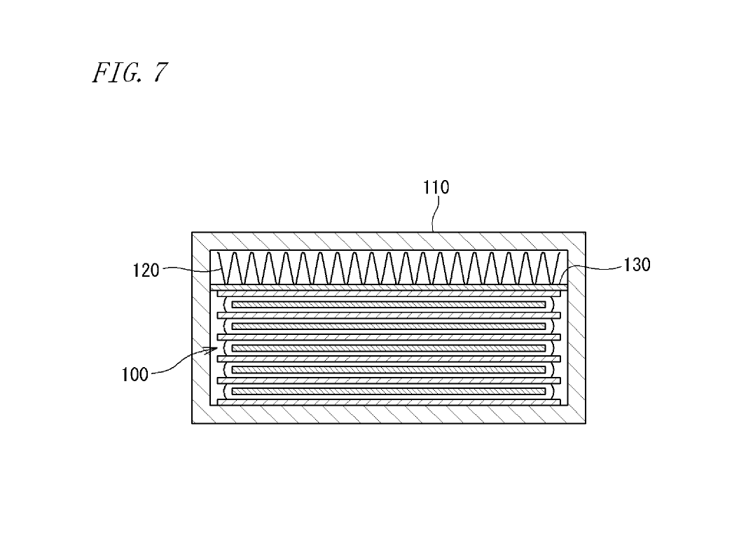

Therefore, it is not necessary to provide an elastic body such as a spring in the battery case 11. When the elastic body is omitted, a space therefor is not needed, and therefore the battery capacity per unit volume (Wh/L) of the molten salt battery is increased. For example, as compared to the configuration in FIG. 7, the thickness dimension in the stacking direction is reduced to about 80%. In this case, the battery capacity per unit volume is increased by a factor of 1.25 provided that there is no difference in lengthwise and crosswise dimensions. Such a reduction in space leads an improvement in efficiency of heating for keeping the molten salt at its melting point or higher. Further, the external pressure based on atmospheric pressure acts uniformly on the surface of the battery case 11, and therefore the presser plate 130 required in the configuration in FIG. 7 is basically unnecessary in this embodiment.

By employing the battery case 11, which is a laminate film, flexibility and air tightness can be easily ensured at low costs, and by appropriately selecting a material of the resin layer, a desired heat-resistant temperature and corrosion resistance can be easily achieved, and also the weight is reduced.

When the molten salt battery produced in the manner described above is heated in its entirety to 85° C. to 95° C. using external heating means, the molten salt is melted, so that charge and discharge can be performed.

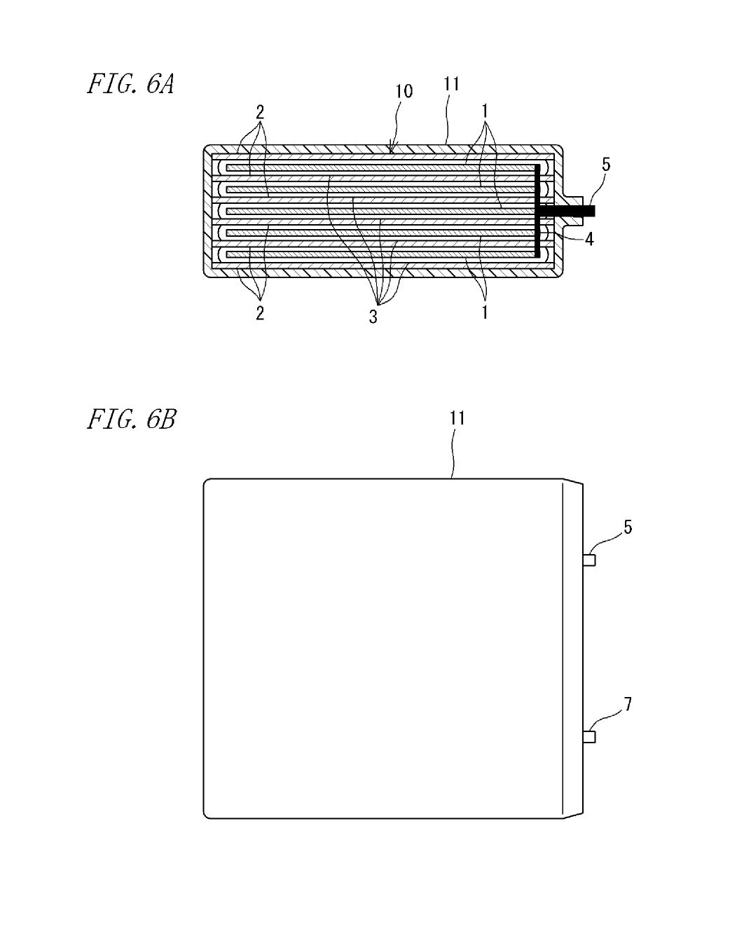

FIG. 5A or FIG. 5B illustrates a state in which terminal parts 5 and 7 are drawn out to the left and the light, respectively, but the terminal parts may be drawn out in the same direction as described above. FIG. 6A and FIG. 6B are a sectional view and a front view, respectively, when terminal parts 5 and 7 are drawn out in the same direction.

The molten salt battery described above can be used at a desired current/voltage rating with a plurality of such molten salt batteries connected to one another in series or in parallel.

In the above-described embodiment, an example is shown in which the whole of the battery case 11 is formed of a laminate film, but the battery case 11 may be a battery case which is formed of a laminate film principally for side surfaces (upper and lower surfaces in FIG. 5A or FIG. 5B), and formed of an inflexible metal such as aluminum for other surfaces. That is, both openings of a rigid rectangular frame are airtightly closed with a laminate film, and the negative pressure is made inside the frame, so that the laminate film compresses the molten salt battery body 10 in the stacking direction. In short, a flexible area may be arranged so that the molten salt battery body 10 can be compressed in the stacking direction by making the negative pressure.

The molten salt in the above-described embodiment is a mixture of NaFSA and KFSA but, alternatively, may be a mixture of LiFSA, KFSA and CsFSA. In the latter case, LiFSA, KFSA and CsFSA is mixed at a molar ratio of 30:35:35. A separator formed of a nonwoven fabric of glass (thickness: 200 μm) is impregnated with the above-mentioned mixture as an electrolyte. The melting point of the mixture is 39° C. In this case, the positive electrode is prepared by contact-bonding to an aluminum nonwoven fabric a mixture of carbon-coated LiFePO₄, acetylene black and a PTFE powder at a weight ratio of 80:15:5. The negative electrode is metal Li, and has an operation temperature of 50° C.

Like a mixture of NaFSA and KFSA, a molten salt of a mixture of LiFSA-KFSA-CsFSA has a relatively low melting point (39° C.), and therefore can be operated at a low level of heating.

In addition, other salts may be mixed (organic cation, etc.), and

(a) a mixture containing NaFSA or LiFSA or

(b) a mixture containing NaTFSA or LiTFSA is generally suitable for the molten salt. In these cases, the molten salt of each mixture has a relatively low melting point, and therefore the molten salt battery can be operated at a low level of heating. A relatively low temperature is sufficient as a heat-resistant temperature required for the battery case 11, so that selection of a material of the battery case 11 is easy.

A configuration in which the negative pressure is made in the battery case as in the above-described embodiment is not suitable for a battery using an organic solvent, like a lithium-ion battery. This is because the organic solvent is vaporized to increase the internal pressure.

Embodiments that are disclosed herein should be considered illustrative, rather than limiting, in all respects. The scope of the present invention is defined by the appended claims, and all changes are intended to be included within descriptions and scopes equivalent to the appended claims.

For example, in this embodiment, an elastic body such as a spring is basically unnecessary in the battery case 11, but the elastic body should not necessarily be excluded, and the elastic body can also be used together as one embodiment. In this case, the effect of achieving a stable even current distribution at the time of charging and discharging is also obtained, and for example when thin rubber or the like that is more space-saving than the spring 120 in FIG. 7 is used, a certain space saving effect is also obtained in comparison with FIG. 7.

### REFERENCE SIGNS LIST

1: Positive electrode

2: Negative electrode

3: Separator

10: Molten salt battery body

11: Battery case

1. A molten salt battery comprising:
a molten salt battery body in which a positive electrode and a negative electrode are alternately stacked with a separator containing molten salt as an electrolyte interposed between the positive electrode and the negative electrode; and
a battery case which is at least partially formed of a material having flexibility and hermetically covers the molten salt battery body while exposing only terminal parts from the positive electrode and negative electrode, the battery case compressing the molten salt battery body in a stacking direction in a state that external pressure based on atmospheric pressure acts on a part of the material with a negative pressure made inside the battery case.

2. The molten salt battery according to claim 1, wherein the battery case is a laminate film which is sealed while covering the molten salt battery body, the laminate film including an aluminum foil and a resin layer.

3. The molten salt battery according to claim 1, wherein the molten salt is a mixture containing NaFSA or LiFSA.

4. The molten salt battery according to claim 1, wherein the molten salt is a mixture containing NaTFSA or LiTFSA.

5. The molten salt battery according to claim 1, wherein the molten salt is a mixture of NaFSA and KFSA, or a mixture of LiFSA, KFSA and CsFSA.

6. A method for producing a molten salt battery including: a molten salt battery body in which a positive electrode and a negative electrode are alternately stacked with a separator containing molten salt as an electrolyte interposed between the positive electrode and the negative electrode; and a battery case which is at least partially formed of a material having flexibility and hermetically covers the molten salt battery body while exposing only terminal parts from the positive electrode and negative electrode, the method comprising:
making a negative pressure inside the battery case while heating is carried out for keeping the molten salt at its melting point or higher to thereby compress the molten salt battery body in a stacking direction in a state that external pressure based on atmospheric pressure acts on a part of the material.

7. The molten salt battery according to claim 2, wherein the molten salt is a mixture containing NaFSA or LiFSA.

8. The molten salt battery according to claim 2, wherein the molten salt is a mixture containing NaTFSA or LiTFSA.

9. The molten salt battery according to claim 2, wherein the molten salt is a mixture of NaFSA and KFSA, or a mixture of LiFSA, KFSA and CsFSA.
